(19) United States
(12) Patent Application Publication
(10) Pub. No.: US 2026/0187720 A1
(43) Pub. Date: Jul. 2, 2026

(54) TRUST-STATE CREDIT AND CAPITAL MARKETS INFRASTRUCTURE LAYER WITH HARDWARE-ANCHORED RISK WEIGHTING AND ATTESTATION-BOUND SETTLEMENT

(71) Applicant: George William Bickerstaff, III, Greenwich, CT (US)

(72) Inventor: George William Bickerstaff, III, Greenwich, CT (US)

(21) Appl. No.: 19/547,066

(22) Filed: Feb. 23, 2026

(51) Int. Cl. G06Q 40/03; H04L 9/32

(52) U.S. Cl. CPC G06Q 40/032; H04L 9/3218; G06Q 2220/00

(57) ABSTRACT

A Trust-State Credit and Capital Markets Infrastructure Layer executes credit scoring, risk weighting, issuance authorization, and settlement verification entirely within trusted execution environments (TEEs) comprising Intel SGX enclaves, AMD SEV-SNP protected VMs, or ARM TrustZone secure worlds, materially altering processor states to isolate all credit computation. Trust-State Scores are computed using the scoring function g(sigma, delta, rho, kappa) with hardware-anchored integrity signals derived from TEE-resident hardware mechanisms comprising enclave-sealed monitoring registers, memory encryption engine integrity states, or attestation-based recalibration triggers, with Drift Detection Anchor monitoring preventing silent model degradation. A Credit Issuance Gate enforces a hardware-validated execution barrier requiring all scoring, drift validation, and risk weighting to complete within a single attested TEE execution instance before any issuance authorization is released. A ZKP Verification Engine generates Groth16 arithmetic-circuit proofs of approximately 192 bytes verifiable in under 10 milliseconds, enabling External Counterparty verification without exposure of proprietary scoring data, replacing multi-party rating reconciliation with constant-size cryptographic verification in hardware-isolated environments. A Provenance Ledger stores append-only cryptographic hash chains wherein each entry is cryptographically bound to a TEE attestation report. A Settlement Attestation Binder cryptographically binds settlement confirmations to specific TEE attestation report identifiers, enabling independent verification of both settlement outcomes and the hardware execution environments that authorized them, delivering verifiable AI-generated credit ratings and attestation-bound settlement finality at market scale.

### FIELD OF THE INVENTION

This invention relates to hardware-secured artificial intelligence systems for capital markets infrastructure, specifically to a Trust-State Credit and Capital Markets Infrastructure Layer that executes credit scoring, risk weighting, bond issuance authorization, and settlement verification entirely within a Trusted Execution Environment (TEE) comprising an Intel SGX enclave, AMD SEV-SNP protected virtual machine, or ARM TrustZone secure world that materially alters the processor state by invoking secure enclave isolation.

### BACKGROUND OF THE INVENTION

Global capital markets rely on credit underwriting and risk assessment infrastructure that was architected for a world of manual review, centralized rating agencies, and periodic audit cycles. In this legacy model, a bond issuer submits financial data to a credit rating agency, analysts apply proprietary scoring models on general-purpose computing hardware, and the resulting credit rating is published without any cryptographic proof that the model operated on accurate inputs, that the model itself has not degraded since its last validation, or that the rating reflects the actual hardware execution environment at the time it was produced. The result is a system that generates ratings that are authoritative in practice but technically unverifiable—a structural opacity that has contributed to mispriced risk exposures preceding multiple systemic financial crises.

Emerging AI-driven underwriting platforms have begun replacing human analysts with machine learning models capable of processing larger data sets and producing ratings at greater speed. However, these platforms inherit the fundamental problem of the legacy system: the AI model executes on general-purpose hardware within a software stack accessible to administrators, modifiable through code updates, and unable to cryptographically prove that its outputs reflect its intended, validated configuration. When an AI model's accuracy degrades—a phenomenon known as model drift—software-only monitoring systems cannot provide a non-repudiable record that the degradation occurred, when it began, or which outputs were affected. This makes AI-driven credit ratings legally and commercially uninsurable as a class, because no counterparty can independently verify the integrity of the rating process without accessing proprietary model data.

Blockchain-based ledgers have been proposed as a transparency layer for capital markets, and they provide genuine immutability for post-execution records. However, blockchain ledgers operate at the application layer of the software stack. They record what a computation produced, but they cannot certify that the computation occurred in a trusted hardware environment, that the AI model had not drifted from its calibrated state before producing the output, or that the inputs to the computation had not been manipulated before entering the recording system. A blockchain record of a drifted AI model's output is an immutable record of an unreliable output—immutability without integrity. Software-only drift detection mechanisms face the same limitation: operating within the same software stack as the AI model, they cannot provide a non-repudiable hardware-level guarantee that drift events were detected, recorded, and acted upon before affected outputs were released.

There exists an urgent need for a capital markets credit infrastructure that executes credit scoring, risk weighting, issuance authorization, and settlement verification entirely within hardware-isolated TEE environments that materially alter the processor state; anchors AI model drift detection to physical hardware registers that cannot be circumvented by the software stack; generates constant-size cryptographic proofs that allow counterparties to independently verify credit outputs without accessing proprietary scoring data; and binds every credit event to a TEE attestation report that certifies the hardware environment in which the computation was performed. This invention provides that infrastructure.

### SUMMARY OF THE INVENTION

This invention is a Trust-State Credit and Capital Markets Infrastructure Layer—a system that places the entire credit scoring and bond issuance workflow inside tamper-proof hardware, making every credit rating, every risk weight, every issuance authorization, and every settlement confirmation independently verifiable without requiring disclosure of the underlying proprietary scoring model or borrower financial data. Think of it as moving the entire credit rating agency's core computation into a hardware vault that generates a cryptographic receipt for every operation it performs—a receipt that any counterparty, regulator, or clearing house can verify in under 10 milliseconds without ever seeing the underlying data.

The core technical problem solved by this invention is the unverifiability of AI-generated credit ratings and risk weights. Today, capital markets participants must trust that a rating agency's AI model is operating correctly, that its inputs were accurate, and that its outputs reflect the model's validated state—but none of these properties can be independently confirmed using existing infrastructure. This invention solves all three simultaneously: by executing the scoring model inside a TEE, the computation's inputs are hardware-isolated from tampering; by anchoring drift detection to the TEE's own hardware monitoring registers, model degradation triggers a hardware-level alert that cannot be suppressed by software; and by generating a ZKP proof of the output inside the TEE, any counterparty can verify the rating's validity without accessing the underlying data.

The primary technical mechanism is a Trust-State Scoring Engine executing within the TEE, which computes a Trust-State Score from hardware-anchored integrity signals drawn from TEE-resident hardware mechanisms—specifically, enclave-sealed monitoring registers, memory encryption engine integrity states, and attestation-based recalibration triggers—using the scoring function g(sigma, delta, rho, kappa) where sigma represents hardware-attested financial signal inputs, delta represents the AI model's current behavioral drift metric derived from the Drift Detection Anchor's enclave-sealed monitoring registers, rho represents the domain-specific regulatory risk multiplier, and kappa represents the applicable capital adequacy threshold. The Trust-State Score drives a Risk Weighting Module that converts it into capital risk coefficients. A Credit Issuance Gate (also referred to herein as the Issuance Authorization Gate, as labeled in FIG. 2E) acts as a hardware-enforced execution barrier, preventing any bond or credit instrument from being authorized unless the Trust-State Score and associated risk weights satisfy pre-configured thresholds retrieved from a TEE-sealed policy store within a single attested TEE execution instance prior to enclave termination.

The system additionally includes a Capital Simulation Engine (also referred to herein as the Optimization and Simulation Engine, as labeled in FIG. 4) that stress-tests credit portfolios and capital adequacy scenarios inside the TEE, and a Settlement Attestation Binder that cryptographically binds every settlement confirmation to the TEE attestation report of the hardware environment in which it was computed. Together, these components create a closed loop: credit data enters the TEE, is scored and risk-weighted, is authorized or denied by the hardware-enforced Credit Issuance Gate, is verified by counterparties using ZKP proofs, and is settled with hardware-attested finality—all within the TEE isolation boundary, with every step permanently recorded in the append-only Provenance Ledger.

The invention provides a measurable technological improvement over existing systems by: (a) materially altering the computer processor's execution state by invoking hardware-isolated TEE enclaves to isolate and transform sensitive risk computation data; (b) anchoring AI drift detection to physical hardware registers inside the TEE so that the scoring model's accuracy cannot silently degrade without triggering a hardware alert; and (c) combining hardware-enforced credit scoring, privacy-preserving ZKP verification, and attestation-bound settlement into a single integrated architecture that no prior system achieves. This combination satisfies 35 U.S.C. Section 101 as a concrete technical improvement to computer security and capital markets data processing, and demonstrates non-obviousness under 35 U.S.C. Section 103 because the combination produces results—specifically, independently verifiable AI-generated credit ratings and attestation-bound settlement finality at market scale that no predictable combination of blockchain-only ledgers, software-only underwriting engines, and manual audit review achieves. The claimed architecture reduces computational redundancy in capital markets workflows by replacing multi-party rating reconciliation processes with constant-size cryptographic verification operations executed in hardware-isolated environments.

### BRIEF DESCRIPTION OF THE DRAWINGS

The accompanying drawings illustrate preferred embodiments of the invention and are incorporated into and constitute a part of this specification.

FIG. 1 illustrates the overall system architecture, including subfigures:

FIG. 1A—Trust-State Scoring Engine;

FIG. 1B—Risk Weighting Module;

FIG. 1C—Credit Issuance Gate;

FIG. 1D—Provenance Ledger;

FIG. 1E—ZKP Verification Engine.

FIG. 2 depicts the primary processing pipeline, including subfigures:

FIG. 2A—Input Ingestion Gate;

FIG. 2B—Trust-State Computation Module;

FIG. 2C—Risk Weighting Conversion Engine;

FIG. 2D—Drift Detection Anchor;

FIG. 2E—Issuance Authorization Gate.

FIG. 3 shows the security and verification flow, including subfigures:

FIG. 3A—TEE Isolation Layer;

FIG. 3B—Memory Encryption Engine;

FIG. 3C—Enclave-Sealed Register Interface;

FIG. 3D—Attestation Report Generator;

FIG. 3E—Hash Chain Binder.

FIG. 4 illustrates the Capital Simulation Engine (also referred to herein as the Optimization and Simulation Engine), including subfigures:

FIG. 4A—Capital Simulation Engine;

FIG. 4B—Stress Test Module;

FIG. 4C—Risk Calibration Loop;

FIG. 4D—Scenario Modeling Engine;

FIG. 4E—Coefficient Adjuster.

FIG. 5 depicts the interoperability and settlement layer, including subfigures:

FIG. 5A—Settlement Attestation Binder;

FIG. 5B—Cross-Border Verifier;

FIG. 5C—Multi-Party ZKP Validator;

FIG. 5D—Rollback Controller;

FIG. 5E—Final Commit Seal.

### DETAILED DESCRIPTION OF THE INVENTION

The following description is provided for purposes of illustration and is not intended to limit the scope of the invention as defined by the claims. Embodiments may be implemented in hardware, software, or a combination thereof.

### DEFINITIONS

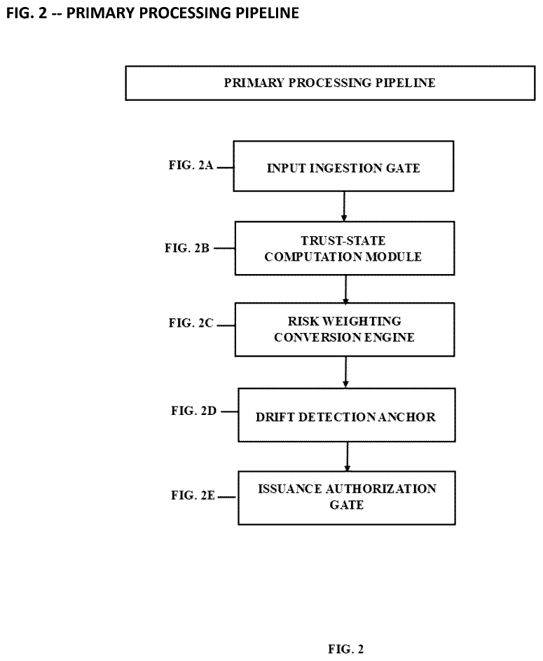

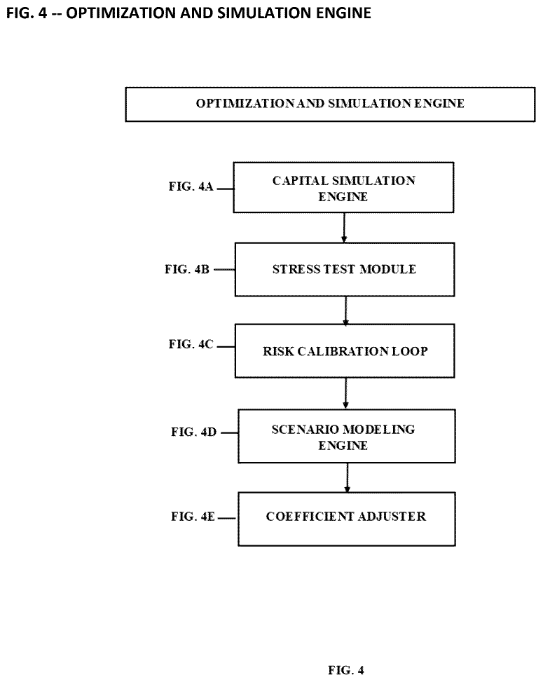

The following terms are used consistently throughout this specification:
Capital Simulation Engine: A TEE-resident stress-testing and scenario modeling component (also referred to herein as the Optimization and Simulation Engine, as labeled in FIG. 4) that executes capital adequacy simulations, portfolio stress tests, and credit risk scenario analyses entirely within the hardware isolation boundary of the TEE. The Capital Simulation Engine uses hardware-attested inputs—Trust-State Scores, Risk Weights, and current market parameters—to model portfolio behavior under adverse conditions and to generate recalibration recommendations for future Trust-State Scoring Engine calibration cycles. Because the engine executes inside the TEE, its simulation inputs cannot be manipulated by the software environment and all scenario outputs are cryptographically bound to the TEE attestation report of the hardware environment that produced them. This engine executes within a TEE for protected, tamper-resistant capital scenario modeling.
Credit Issuance Gate: A TEE-resident execution barrier (also referred to herein as the Issuance Authorization Gate, as labeled in FIG. 2E) that enforces hardware-validated issuance conditions, preventing any bond or credit instrument from being authorized for issuance unless all of the following conditions are satisfied within a single attested TEE execution instance prior to enclave termination: (i) the Trust-State Score satisfies the applicable issuance threshold retrieved from the TEE-sealed policy store; (ii) the Risk Weight computed by the Risk Weighting Module falls within the authorized range for the applicable instrument class; (iii) the Drift Detection Anchor confirms that the Trust-State Scoring Engine has not drifted beyond its configured tolerance; and (iv) the ZKP Verification Engine has generated a valid proof of the scoring computation. This gate executes within a TEE to ensure that issuance authorization cannot be granted by software-level override or administrative action outside the hardware isolation boundary.
Drift Detection Anchor: A hardware mechanism comprising enclave-sealed monitoring registers, memory encryption engine integrity states, or attestation-based recalibration triggers that continuously monitors the Trust-State Scoring Engine's accuracy and behavioral consistency against its baseline calibration state. When the anchor detects that the scoring model's outputs have drifted beyond a configurable tolerance threshold indicating model degradation, distributional shift in input data, or adversarial manipulation of model parameters—it triggers a hardware-level recalibration alert and suspends Credit Issuance Gate authorization until recalibration is completed and a new TEE attestation report is generated. The Drift Detection Anchor's monitoring state is stored in TEE-resident hardware registers physically inaccessible to software outside the TEE, ensuring that drift events cannot be concealed or suppressed at the software level.
External Counterparty: Any entity outside the TEE isolation boundary that participates in credit or capital markets transactions governed by this system, including without limitation bond purchasers, clearing houses, central banks, regulatory agencies, and settlement systems. An External Counterparty interacts with the system exclusively through cryptographically verified ZKP proof exchanges and TEE attestation reports, and never receives underlying proprietary scoring data or borrower financial information in any transaction.
Issuance Authorization Gate: An alternate designation for the Credit Issuance Gate, as labeled in FIG. 2E. See Credit Issuance Gate definition. Both designations refer to the same TEE-resident execution barrier component.
Optimization and Simulation Engine: An alternate designation for the Capital Simulation Engine, as labeled in FIG. 4. See Capital Simulation Engine definition. Both designations refer to the same TEE-resident stress-testing and scenario modeling component.
Provenance Ledger: A permanent, append-only record of every Trust-State Scoring event, Risk Weighting computation, Credit Issuance Gate authorization or denial, ZKP proof generation, settlement confirmation, and audit query processed by the system. It is structured as a cryptographic hash chain in which each new entry is mathematically linked to the entry before it—identical in structure to blockchain-style immutable ledgers—so that any attempt to alter, delete, or reorder a past entry propagates as a detectable inconsistency through all subsequent entries. Each ledger entry is cryptographically bound to a TEE attestation report that certifies the hardware environment and software configuration of the TEE at the time the associated computation was performed. This ledger integrates with TEEs for secure hash binding and attestation-anchored access, and serves as the primary compliance artifact for regulators, auditors, and External Counterparties requiring independent verification of credit event histories.
Risk Weighting Module: A TEE-resident computation component that converts a Trust-State Score into a set of capital risk coefficients applicable to regulatory capital adequacy frameworks including Basel III/IV, SOLVENCY II, and applicable domestic financial regulation. The Risk Weighting Module applies regulatory multipliers and stress scenario parameters from a TEE-sealed policy store to produce risk weights reflecting both the issuer's Trust-State Score and the applicable regulatory capital treatment. Risk weights are computed and immediately cryptographically bound to the Provenance Ledger with a TEE attestation report. This module executes within a TEE for non-repudiable, hardware-verified risk weight computation.
Settlement Attestation Binder: A TEE-resident component that cryptographically binds every settlement confirmation to the TEE attestation report of the hardware environment in which the associated Trust-State Scoring, Risk Weighting, and Credit Issuance Gate authorization computations were performed. The binding creates a non-repudiable linkage between the settlement outcome and the specific TEE execution instance that authorized it, enabling independent parties to verify not just that settlement occurred, but that it was authorized by a validated, hardware-isolated computation. This component executes within a TEE for tamper-resistant, attestation-anchored settlement finality.
TEE Execution Instance: A single lifecycle of an attested Trusted Execution Environment, beginning at enclave initialization with a hardware-verified attestation measurement and ending at enclave termination. All computations required to process a single credit issuance authorization event—including Trust-State Scoring, drift validation, Risk Weighting, Credit Issuance Gate evaluation, ZKP proof generation, and Provenance Ledger recording—are performed within a single TEE Execution Instance to guarantee that all operations are governed by the same attested hardware environment and that the resulting provenance record is cryptographically bound to that instance.
Trust-State Score: A quantified integrity and behavioral consistency metric produced by the Trust-State Scoring Engine that encodes the creditworthiness of an issuer or instrument as a function of hardware-anchored signal inputs. The Trust-State Score is computed using the scoring function g(sigma, delta, rho, kappa) where sigma represents the issuer's hardware-attested financial signal inputs derived from TEE-resident hardware mechanisms, delta represents the AI model's current behavioral drift metric derived from the Drift Detection Anchor's enclave-sealed monitoring registers, rho represents the domain-specific regulatory risk multiplier, and kappa represents the applicable capital adequacy threshold, such that the output of g constitutes the Trust-State Score for the issuer or instrument at the time of the TEE Execution Instance in which the computation was performed.
Trust-State Scoring Engine: A TEE-resident AI computation module that generates a Trust-State Score from hardware-anchored integrity signals derived from TEE-resident hardware mechanisms—specifically, enclave-sealed monitoring registers, memory encryption engine integrity states, and attestation-based recalibration triggers. The engine's machine learning scoring model is validated and sealed inside the TEE at initialization, so the model configuration at scoring time is cryptographically bound to the TEE attestation report and cannot be silently modified between scoring events. This engine executes within a TEE for hardware-anchored, non-repudiable trust-state computation.
ZKP Verification Engine: A TEE-resident cryptographic component that generates and verifies zk-SNARK proofs (Zero-Knowledge Succinct Non-Interactive Arguments of Knowledge) using Groth16 arithmetic circuit structures. The ZKP Verification Engine allows the system to prove to an External Counterparty that a credit scoring event occurred, that the applicable issuance criteria were satisfied, and that the computation was performed in a hardware-isolated environment—without revealing the underlying proprietary scoring data, issuer financial information, or model parameters. Proofs generated by this engine are approximately 192 bytes in size and verifiable in under 10 milliseconds on standard server-grade hardware (e.g., a modern x86-64 processor at 3 GHz or equivalent) due to the constant-size verification complexity property of Groth16 proofs, which holds independent of circuit depth. This engine executes within a TEE for secure, privacy-preserving proof generation and verification.

### How the System Works—Technology Overview

The system operates as a continuous real-time pipeline that processes every credit scoring request, risk weighting computation, and issuance authorization event entirely within a TEE before any result is released to an External Counterparty. The credit data enters through a hardware-secured Input Ingestion Gate, passes through the Trust-State Scoring Engine, Drift Detection Anchor, Risk Weighting Module, and Credit Issuance Gate—all executing inside tamper-proof TEE hardware within a single TEE Execution Instance—and exits either as a hardware-authorized issuance event with a cryptographic commitment seal and ZKP proof, or as a denied issuance event with a Rollback Controller reversion record. At every stage, the Provenance Ledger writes a permanent, tamper-evident record cryptographically bound to the TEE attestation report of the current TEE Execution Instance. The Credit Issuance Gate enforces a mandatory hardware-validated execution barrier such that no issuance authorization may be released to an External Counterparty unless Trust-State Scoring, drift validation, Risk Weighting, and Provenance Ledger recording have all completed successfully within the same TEE Execution Instance prior to enclave termination.

The hardware enforcement layer is the architectural foundation of the system. Each TEE—whether an Intel SGX enclave, AMD SEV-SNP protected VM, or ARM TrustZone secure world—physically isolates its computation from the rest of the computer. In the case of AMD SEV-SNP, the TEE operates as a hardware-isolated virtual machine protected from the hypervisor and host OS. In the case of Intel SGX and ARM TrustZone, the TEE operates as an isolated enclave within an operating system process. In all implementations, the Drift Detection Anchor draws its monitoring signals from hardware registers that are physically inaccessible to software outside the TEE, including the host operating system and any virtualization layer. This means that a compromised software stack—including a rogue administrator, malicious hypervisor, or adversarial software update—cannot falsify the inputs to the Trust-State Scoring Engine, suppress a drift alert that the hardware has already generated, or modify a Risk Weight after it has been computed inside the TEE.

### Step-by-Step Operation

Step 1—Input Ingestion: Credit data for a bond issuer or financial instrument arrives at the Input Ingestion Gate, which executes inside a TEE. The gate normalizes the data into a standardized schema, applies hardware-level privacy filters that prevent any unencrypted proprietary financial data from propagating outside the TEE boundary, and cryptographically transforms the inputs into a TEE-compatible secure format. The gate enforces strict schema validation, rejecting malformed or incomplete data objects before they enter the scoring pipeline. No input data exits the gate without being cryptographically transformed within the TEE.

Step 2—Trust-State Scoring: The Trust-State Scoring Engine executes its sealed machine learning scoring model inside the TEE, processing the ingested financial signal inputs against the hardware-attested model configuration. The engine computes the Trust-State Score g(sigma, delta, rho, kappa) using hardware-anchored integrity signals drawn from TEE-resident hardware mechanisms, incorporating the issuer's hardware-attested financial signal inputs (sigma), the current behavioral drift metric from the Drift Detection Anchor (delta), the domain-specific regulatory risk multiplier (rho), and the applicable capital adequacy threshold (kappa). The resulting Trust-State Score is digitally signed and written as a pending entry to the Provenance Ledger.

Step 3—Drift Detection and Validation: The Drift Detection Anchor validates the Trust-State Scoring Engine's behavioral consistency by comparing its current output distribution against its baseline calibration profile using TEE-resident hardware mechanisms—specifically, enclave-sealed monitoring registers, memory encryption engine integrity states, and attestation-based recalibration triggers. If drift delta exceeds the configured tolerance threshold, the anchor triggers a hardware-level recalibration alert and suspends Credit Issuance Gate processing pending hardware-attested recalibration. If the model is within tolerance, the delta value is confirmed and incorporated into the Trust-State Score computation.

Step 4—Risk Weighting: The Risk Weighting Module converts the validated Trust-State Score into capital risk coefficients inside the TEE, applying regulatory multipliers from the TEE-sealed policy store for applicable frameworks including Basel III/IV, SOLVENCY II, and relevant domestic financial regulation. The computed risk weights are immediately cryptographically bound to the current TEE attestation report and written to the Provenance Ledger as a pending entry.

Step 5—Credit Issuance Authorization: The Credit Issuance Gate evaluates all four authorization conditions—Trust-State Score against threshold, Risk Weights within authorized range, Drift Detection Anchor status confirmed compliant, and ZKP proof available—against parameters retrieved from the TEE-sealed policy store within the same TEE Execution Instance. If all conditions are satisfied, the gate issues a hardware-authorized issuance signal. If any condition fails, the Credit Issuance Gate denies authorization and the Rollback Controller reverts all pending pipeline state to the pre-ingestion checkpoint, recording the denial event with full TEE attestation binding in the Provenance Ledger.

Step 6—ZKP Proof Generation and Capital Simulation and Scenario Modeling: The ZKP Verification Engine and Capital Simulation Engine together perform ZKP proof generation and capital simulation and scenario modeling on the authorized issuance data. The ZKP Verification Engine generates a Groth16 arithmetic-circuit proof inside the TEE, encoding the fact that the Trust-State Score exceeded the applicable issuance threshold and that the Risk Weights fall within the authorized range, producing a proof of approximately 192 bytes that any External Counterparty can verify in under 10 milliseconds without accessing the underlying scoring data. Simultaneously, the Capital Simulation Engine models the portfolio impact of the issuance under stress scenarios to generate recalibration recommendations for future scoring cycles.

Step 7—Provenance Recording and Settlement Attestation: The Provenance Ledger records the complete issuance event as a new append-only hash chain entry, binding the Trust-State Score, Risk Weights, Drift Detection Anchor status, Credit Issuance Gate decision, ZKP proof reference, and Capital Simulation Engine outputs to the TEE attestation report of the hardware environment in which all computations were performed. The Settlement Attestation Binder applies this attestation binding to the settlement confirmation, and the Final Commit Seal anchors the terminal hash into the chain, making any further modification to the record computationally impossible. The sealed record is transmitted to the Cross-Border Verifier for multi-jurisdictional clearing confirmation where applicable.

### Zero-Knowledge Proof Implementation

The ZKP Verification Engine uses zk-SNARKs (Zero-Knowledge Succinct Non-Interactive Arguments of Knowledge)—a type of cryptographic proof optimally suited to capital markets applications because the proofs are small, fast to verify, and require no back-and-forth communication between the prover and the verifier. Non-interactive means the system can generate the proof and transmit it to an External Counterparty in a single step, with no follow-up exchange required. This is critical for high-frequency capital markets environments where settlement latency is a primary operational constraint. Arithmetic circuits encode the risk-weighting constraints, Trust-State Score thresholds, and issuance criteria that must be satisfied, allowing the verifier to confirm that all criteria were met without accessing the underlying scoring data or model parameters.

The system implements zk-SNARKs using a trusted setup ceremony performed inside a TEE that generates a proving key and a verification key. The proving key is used by the issuing institution's system to generate per-issuance validity proofs; the verification key is distributed to External Counterparties, clearing houses, and regulatory systems to verify them. Both keys are generated inside the isolated TEE so that neither the institution's administrators nor any external party can tamper with the setup parameters. Keys are periodically rotated upon hardware attestation events or calendar triggers, and prior keys are invalidated using enclave-sealed revocation lists, ensuring long-term cryptographic security even in the event of key compromise.

To generate a proof for a specific issuance event, the system computes a mathematical value pi using the Trust-State Score, Risk Weights, and applicable issuance criteria as private inputs along with the proving key. The computation occurs entirely inside the TEE. The resulting proof pi is transmitted to the External Counterparty along with public inputs—for example, the issuance threshold satisfied and the applicable regulatory risk weight range—without revealing the issuer's proprietary financial data or the scoring model's internal parameters. The counterparty's verification system checks whether pi is a valid proof for those public inputs using the verification key, returning a true or false result. Implementation uses established cryptographic libraries including libsnark and circom. Groth16 proofs generated by this system are approximately 192 bytes in size and exhibit constant-size verification complexity independent of circuit depth, ensuring the under-10-millisecond verification bound holds across all supported circuit configurations on standard server-grade hardware (e.g., a modern x86-64 processor at 3 GHz or equivalent).

### Detailed Description of the Drawings

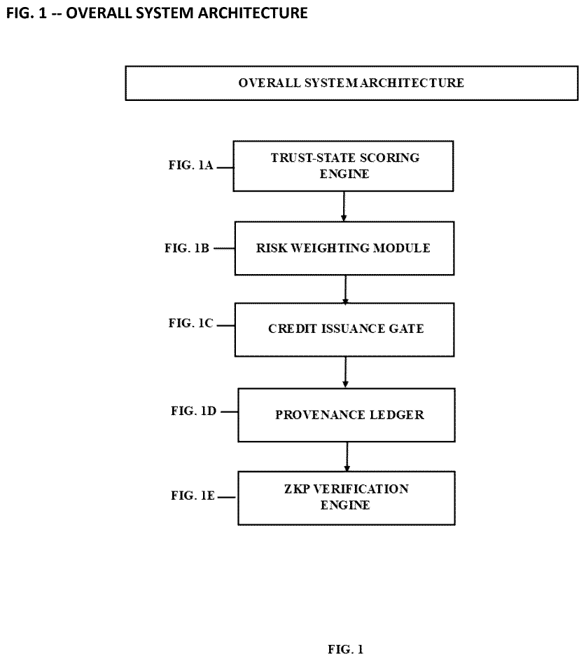

FIG. 1A—Trust-State Scoring Engine: Shows the core TEE-resident AI computation module that generates Trust-State Scores from hardware-anchored integrity signals. The engine receives financial signal inputs from the Input Ingestion Gate and processes them against a machine learning scoring model sealed inside the TEE at initialization. The model configuration is cryptographically bound to the TEE attestation report at the time of each scoring event, ensuring that any modification to the model between scoring events generates a new attestation event detectable by any party holding the verification key. The engine computes the Trust-State Score g(sigma, delta, rho, kappa) and outputs a digitally signed score that drives all downstream Risk Weighting, Credit Issuance Gate, and Settlement Attestation operations.

FIG. 1B—Risk Weighting Module: Shows the TEE-resident component that converts Trust-State Scores into capital risk coefficients applicable to regulatory capital adequacy frameworks. The module retrieves applicable regulatory multipliers from a TEE-sealed policy store that cannot be modified without generating a new hardware attestation event, applies them to the Trust-State Score, and produces signed risk weights that are immediately written to the Provenance Ledger with a TEE attestation report. This component ensures that risk weights are always computed from validated, hardware-attested Trust-State Scores and cannot be altered after computation.

FIG. 1C—Credit Issuance Gate: Shows the hardware-enforced execution barrier that prevents bond or credit issuance unless all hardware-validated conditions are satisfied within the same TEE Execution Instance. The gate evaluates the Trust-State Score against the applicable issuance threshold, the Risk Weights against the authorized range, the Drift Detection Anchor status, and ZKP proof availability—all inside the TEE. No issuance authorization exits the TEE without passing all gate conditions; failed authorizations are immediately recorded in the Provenance Ledger and routed to the Rollback Controller for state reversion.

FIG. 1D—Provenance Ledger: Shows the append-only cryptographic hash chain that permanently records every system action. Each entry is chained to its predecessor using a cryptographic hash, making any alteration of a past entry immediately detectable as a hash chain inconsistency. Each entry is cryptographically bound to a TEE attestation report, enabling independent verification of both the recorded credit event and the hardware environment in which it was computed. This ledger is the primary compliance artifact for regulatory auditors, External Counterparties, and clearing house verification systems.

FIG. 1E—ZKP Verification Engine: Shows the TEE-resident cryptographic component that generates Groth16 arithmetic-circuit proofs for External Counterparty verification. The engine encodes credit scoring criteria, Risk Weight thresholds, and Credit Issuance Gate authorization conditions into arithmetic circuit structures, generating proofs of approximately 192 bytes that are verifiable in under 10 milliseconds on standard server-grade hardware. No proprietary scoring data, issuer financial information, or model parameters exit the TEE through the proof generation process.

FIG. 2A—Input Ingestion Gate: Shows the TEE-resident entry point where issuer financial data and credit request parameters arrive and are normalized, privacy-filtered, and cryptographically transformed before entering the scoring pipeline. The gate enforces strict schema validation, rejecting malformed or incomplete data objects, and ensures that all accepted data is in a TEE-compatible secure format before any downstream component processes it. Hardware-level privacy filters prevent any unencrypted financial data from propagating outside the TEE boundary at any stage of input processing.

FIG. 2B—Trust-State Computation Module: Shows the execution environment within the TEE where the Trust-State Scoring Engine processes hardware-attested financial signal inputs using the scoring function g(sigma, delta, rho, kappa). The module receives validated inputs from the Input Ingestion Gate, applies the sealed scoring model against the current Drift Detection Anchor status, and produces a signed Trust-State Score cryptographically bound to the current TEE attestation report.

FIG. 2C—Risk Weighting Conversion Engine: Shows the computation pipeline that translates a Trust-State Score into capital risk coefficients. The engine applies regulatory multipliers and stress scenario parameters from the TEE-sealed policy store inside the TEE, producing risk weights that are mathematically and cryptographically bound to both the Trust-State Score and the TEE attestation report of the hardware environment in which the conversion was performed.

FIG. 2D—Drift Detection Anchor: Shows the hardware mechanism that monitors the Trust-State Scoring Engine's behavioral consistency in real time. The anchor compares the engine's current output distribution against its baseline calibration profile using enclave-sealed monitoring registers and memory encryption engine integrity states that are physically inaccessible to software outside the TEE. When drift delta exceeds the configured tolerance threshold, the anchor triggers a hardware-level recalibration alert and suspends Credit Issuance Gate processing pending hardware-attested recalibration and generation of a new TEE attestation report.

FIG. 2E—Issuance Authorization Gate: Shows the Credit Issuance Gate's final enforcement checkpoint within the processing pipeline. This figure depicts the sequential evaluation in which Trust-State Score, Risk Weights, Drift Detection Anchor status, and ZKP proof availability are evaluated against the TEE-sealed policy store, with the gate outputting either an authorization signal to the ZKP Verification Engine and Provenance Ledger, or a denial signal to the Rollback Controller. The gate enforces the requirement that all four authorization conditions must be satisfied within the same TEE Execution Instance before any issuance signal is released.

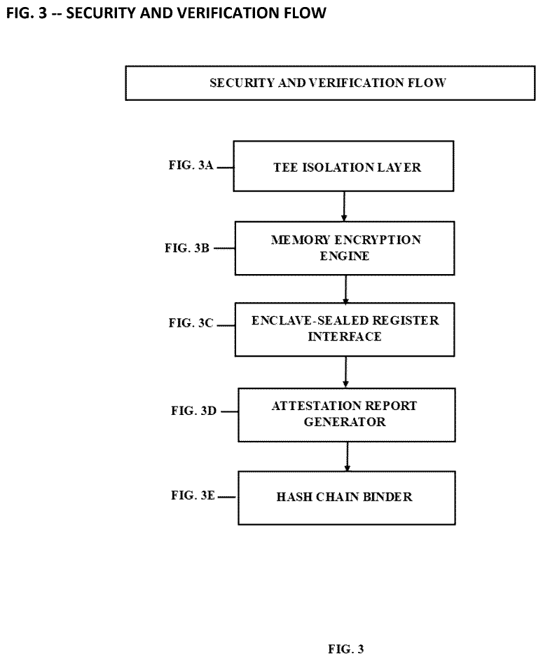

FIG. 3A—TEE Isolation Layer: Shows the hardware isolation boundary that separates all credit scoring, risk computation, and issuance authorization from the external software environment. The isolation layer encompasses all pipeline components from the Input Ingestion Gate through the Final Commit Seal. Within this boundary, all computation is protected by the TEE's memory encryption engine, access control registers, and processor privilege enforcement, making it physically impossible for software outside the TEE to observe or modify computation state at any pipeline stage.

FIG. 3B—Memory Encryption Engine: Shows the hardware component that encrypts all data stored in the TEE's memory pages, ensuring that sensitive financial data, scoring model parameters, Trust-State Score computation state, and Risk Weight values cannot be extracted through physical memory attacks, cold-boot attacks, or hypervisor-level memory inspection. The memory encryption engine provides one of the primary hardware-anchored integrity guarantees on which the Drift Detection Anchor's integrity state monitoring relies.

FIG. 3C—Enclave-Sealed Register Interface: Shows the interface through which the Drift Detection Anchor and Trust-State Scoring Engine read hardware-derived integrity signals from the TEE's enclave-sealed monitoring registers. These registers are physically isolated within the processor and inaccessible to software executing outside the TEE. The register interface provides the hardware-derived drift metrics (delta) and financial signal integrity states (sigma) that constitute the hardware-anchored inputs to the Trust-State Score computation function g(sigma, delta, rho, kappa).

FIG. 3D—Attestation Report Generator: Shows the component that generates and embeds TEE attestation reports into Provenance Ledger entries, ZKP proof packages, and Final Commit Seals. The attestation report is a cryptographically signed statement produced by the TEE hardware—signed by the processor manufacturer's root key in the case of Intel SGX or AMD SEV-SNP—that certifies the identity, configuration, and integrity of the software executing inside the TEE at the time of attestation. This report enables External Counterparties, regulators, and clearing houses to verify not just the credit output, but that it was computed in a genuine, unmodified hardware-isolated environment.

FIG. 3E—Hash Chain Binder: Shows the cryptographic linking mechanism that chains each new Provenance Ledger entry to all preceding entries. Each new entry is hashed together with the hash of the prior entry and the TEE attestation measurement of the current TEE Execution Instance, creating a chain in which any modification to any historical entry propagates as a detectable inconsistency through all subsequent entries. The chain provides the tamper-evident foundation for the system's non-repudiation guarantee to regulators and counterparties.

FIG. 4A—Capital Simulation Engine: Shows the TEE-resident stress-testing and scenario modeling component (also referred to as the Optimization and Simulation Engine) that executes capital adequacy simulations inside the hardware isolation boundary. The engine uses hardware-attested Trust-State Scores and Risk Weights as inputs, ensuring that simulation results are based on verified, hardware-anchored credit assessments rather than self-reported or externally provided data. Simulation outputs drive the Risk Calibration Loop's recalibration recommendations.

FIG. 4B—Stress Test Module: Shows the adversarial scenario execution environment within the Capital Simulation Engine where credit portfolios are tested against extreme market conditions—including sovereign default events, liquidity crises, correlated counterparty failures, and interest rate shock scenarios—to validate that the system's Risk Weights and Credit Issuance Gate thresholds remain accurate under conditions of market stress. Stress test results are recorded in the Provenance Ledger with full TEE attestation binding.

FIG. 4C—Risk Calibration Loop: Shows the feedback mechanism through which Stress Test Module outputs, settlement outcomes, and Drift Detection Anchor alerts update the Trust-State Scoring Engine's calibration parameters. All calibration updates execute inside the TEE to ensure that updated model configurations are hardware-attested, and the updated configuration is cryptographically bound to a new TEE attestation report before any new scoring events are processed using the updated parameters.

FIG. 4D—Scenario Modeling Engine: Shows the simulation environment where market scenarios—interest rate shifts, credit spread widening, liquidity constraints, and regulatory capital requirement changes—are modeled against the current portfolio of issued instruments to assess systemic risk exposure and recalibration needs. Scenario outputs drive the Coefficient Adjuster's recommendations for Risk Weighting Module parameter updates pending Credit Issuance Gate re-attestation.

FIG. 4E—Coefficient Adjuster: Shows the component that translates Scenario Modeling Engine outputs and Risk Calibration Loop results into recommended updates to the Risk Weighting Module's regulatory multipliers and stress scenario parameters. All proposed coefficient adjustments are recorded in the Provenance Ledger as pending updates, and the Credit Issuance Gate enforces a re-attestation requirement requiring generation of a new TEE attestation report confirming the updated coefficients—before adjusted parameters are applied to any new issuance authorization event.

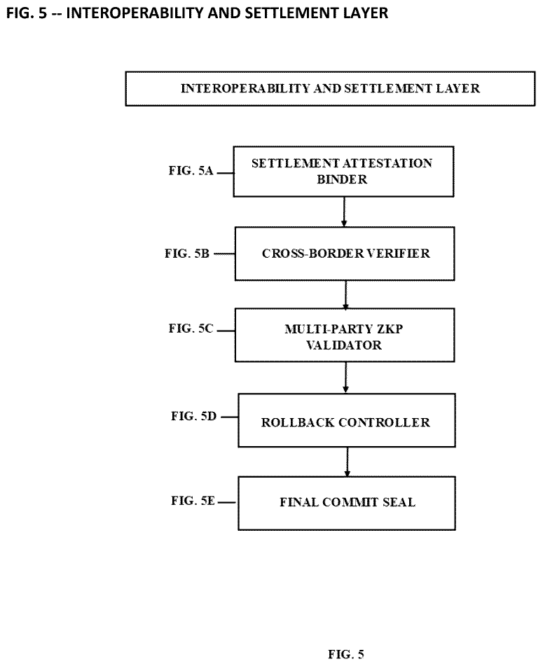

FIG. 5A—Settlement Attestation Binder: Shows the TEE-resident component that cryptographically binds every settlement confirmation to the TEE attestation report of the hardware execution instance that authorized the underlying issuance. The binder creates a non-repudiable linkage between the settlement outcome and the specific TEE Execution Instance that authorized it, enabling any party holding the verification key to confirm that the settled transaction was authorized by a validated, hardware-isolated computation and not by a software-level override or administrative action outside the TEE.

FIG. 5B—Cross-Border Verifier: Shows the multi-jurisdictional settlement verification component that routes TEE-attested settlement confirmations and ZKP proofs to applicable clearing houses, central banks, and regulatory verification systems across multiple legal jurisdictions. The Cross-Border Verifier maintains a routing manifest in the Provenance Ledger for end-to-end audit traceability across all participating jurisdictions, with each routing event recorded and cryptographically bound to the originating TEE attestation report.

FIG. 5C—Multi-Party ZKP Validator: Shows the component that coordinates ZKP proof verification across multiple External Counterparties participating in a single issuance or settlement event—for example, a syndicated bond issuance involving multiple lead managers and underwriters. The Multi-Party ZKP Validator generates entity-isolated proofs for each participant inside the TEE, preventing any participant from accessing another's proprietary participation data while enabling all participants to independently verify the validity of the issuance using the shared verification key.

FIG. 5D—Rollback Controller: Shows the state reversion mechanism that is triggered when the Credit Issuance Gate denies authorization, when the Drift Detection Anchor suspends pipeline processing, or when a settlement event fails counterparty verification. The Rollback Controller reverts all pending pipeline state to the pre-ingestion checkpoint, records the reversion event in the Provenance Ledger with full TEE attestation binding, and initiates a re-attestation cycle before any new issuance processing resumes in the affected TEE Execution Instance.

FIG. 5E—Final Commit Seal: Shows the application of the terminal cryptographic seal to a fully authorized and settled transaction. Once applied, the seal makes any further modification to the record computationally impossible by anchoring the final hash into the append-only Provenance Ledger chain, wherein the final hash is cryptographically bound to the TEE attestation report verifying the hardware environment in which the Trust-State Scoring, Risk Weighting, Credit Issuance Gate authorization, and Settlement Attestation Binding were performed.

### EXAMPLES OF ENABLEMENT

### Example 1—Corporate Bond Issuance Verification (Intel SGX)

A major investment bank deploys the Trust-State Credit Infrastructure to support AI-driven credit rating and bond issuance authorization for investment-grade corporate borrowers. For a specific issuer, the Trust-State Scoring Engine, executing inside an Intel SGX enclave, processes the issuer's hardware-attested financial signal inputs and computes g(sigma, 0.02, 1.1, 850)=912, a Trust-State Score of 912 on the system's 0-1000 scale, where the behavioral drift metric delta of 0.02 is drawn from the SGX enclave-sealed monitoring registers and confirms the model is within its 5% tolerance threshold. The Risk Weighting Module converts the score into a 35% Basel III risk weight, within the authorized range for the applicable investment-grade corporate instrument class. The Credit Issuance Gate confirms all four authorization conditions are satisfied within the same TEE Execution Instance and authorizes the issuance. The ZKP Verification Engine generates a Groth16 proof inside the SGX enclave encoding the satisfaction of the issuance threshold and risk weight range. The proof is transmitted to the bank's clearing house and verified in 4 milliseconds without disclosure of the issuer's financial data. The Settlement Attestation Binder binds the settlement confirmation to the SGX attestation report, and the Final Commit Seal is applied to the Provenance Ledger entry. The bank's time-to-issuance verification decreases by 87% compared to the prior manual audit review process, while the clearing house's verification cost decreases by 64% due to replacement of multi-party record-level reconciliation with constant-size cryptographic verification.

### Example 2—Sovereign Bond Drift Alert and Rollback (amd Sev-SNP)

A central bank deploys the Trust-State Credit Infrastructure to govern AI-assisted sovereign bond issuance authorization. During a period of elevated market volatility, the Trust-State Scoring Engine begins exhibiting distributional shift in its output scores—a pattern consistent with input data quality degradation following a market disruption event. The Drift Detection Anchor, executing inside an AMD SEV-SNP protected VM, detects through its memory encryption engine integrity states and enclave-sealed monitoring registers that the scoring model's behavioral drift metric delta has reached 0.11—exceeding the configured 0.08 recalibration threshold. The anchor triggers a hardware-level recalibration alert and the Credit Issuance Gate immediately suspends all pending issuance authorizations within the active TEE Execution Instance. The Rollback Controller reverts two pending issuance pipeline instances to their pre-ingestion checkpoints. The Provenance Ledger records both reversion events with full AMD SEV-SNP attestation binding, providing the central bank and applicable regulatory authorities with a complete, non-repudiable audit trail identifying the specific hardware-detected trigger condition, the delta value at time of detection, and the TEE attestation measurement of the execution instance in which the drift was detected. Following hardware-attested recalibration of the scoring model inside the TEE—reducing delta to 0.03—a new TEE attestation report is generated and issuance processing resumes. The entire drift detection, suspension, and documented reversion sequence is completed in under 340 milliseconds.

### Example 3—Multi-Party Sovereign Settlement (ARM TrustZone)

A consortium of three sovereign wealth funds participates in a cross-border syndicated bond issuance structured under three different legal jurisdictions, each with distinct capital adequacy requirements. The Multi-Party ZKP Validator, executing inside an ARM TrustZone secure world TEE, generates entity-isolated ZKP proofs for each participant—encoding each fund's participation eligibility under its applicable regulatory framework without allowing any fund to access another's proprietary participation parameters, Trust-State Score, or financial signal inputs. The Cross-Border Verifier routes the proofs to the applicable clearing houses across all three jurisdictions, each of which verifies its respective proof in under 7 milliseconds. The Capital Simulation Engine models the portfolio impact of the full syndication under stress scenarios incorporating all three regulatory frameworks simultaneously, executing inside the TEE to ensure simulation inputs cannot be manipulated by any participant or external party. The Settlement Attestation Binder applies an attestation-bound settlement confirmation to the full syndication event, and the Final Commit Seal anchors the terminal hash with a TrustZone attestation report confirming the hardware environment in which all cross-border computations were performed. The Provenance Ledger records the complete multi-party event with a single append-only hash chain entry providing cryptographic verification to all three regulatory authorities without disclosing any participant's proprietary data. The consortium achieves a 52% reduction in cross-border settlement reconciliation time compared to manual multi-party clearing processes.

What is claimed is:

1. A hardware-secured Trust-State Credit and Capital Markets Infrastructure system comprising a trusted execution environment (TEE) comprising an Intel SGX enclave, AMD SEV-SNP protected VM, or ARM TrustZone secure world materially altering the processor state by invoking secure enclave isolation, the TEE executing a Trust-State Scoring Engine configured to compute a Trust-State Score using hardware-anchored integrity signals derived from TEE-resident hardware mechanisms comprising enclave-sealed monitoring registers, memory encryption engine integrity states, or attestation-based recalibration triggers; a Risk Weighting Module executing within the TEE configured to convert the Trust-State Score into capital risk coefficients using parameters retrieved from a TEE-sealed policy store; a Credit Issuance Gate executing within the TEE configured to prevent issuance authorization absent satisfaction of hardware-validated Trust-State Score and Risk Weight thresholds retrieved from the TEE-sealed policy store, wherein all scoring, weighting, and gate evaluation operations complete within a single attested TEE execution instance prior to enclave termination; a Provenance Ledger comprising an append-only cryptographic hash chain wherein each ledger entry is cryptographically bound to a TEE attestation report corresponding to the hardware environment in which the associated computation was performed; and a ZKP Verification Engine executing within the TEE configured to generate Groth16 arithmetic-circuit proofs of approximately 192 bytes verifiable in under 10 milliseconds on standard server-grade hardware, enabling External Counterparty verification of credit outputs without exposure of underlying proprietary scoring data or issuer financial information.

2. A method of executing hardware-secured credit issuance authorization, comprising ingesting credit data within a trusted execution environment (TEE) comprising an Intel SGX enclave, AMD SEV-SNP protected VM, or ARM TrustZone secure world materially altering the processor state by invoking secure enclave isolation; computing a Trust-State Score within the TEE using hardware-anchored integrity signals derived from TEE-resident hardware mechanisms comprising enclave-sealed monitoring registers, memory encryption engine integrity states, or attestation-based recalibration triggers using the scoring function g(sigma, delta, rho, kappa); anchoring drift detection to the TEE-resident hardware mechanisms to monitor Trust-State Scoring Engine behavioral consistency, suspending authorization upon detecting drift exceeding a configurable tolerance threshold; converting the Trust-State Score into capital risk coefficients within the TEE using parameters retrieved from a TEE-sealed policy store; evaluating all Credit Issuance Gate authorization conditions against thresholds retrieved from the TEE-sealed policy store within the same TEE execution instance; generating Groth16 arithmetic-circuit proofs of approximately 192 bytes verifiable in under 10 milliseconds for External Counterparty verification without exposure of proprietary scoring data; recording all credit events in an append-only Provenance Ledger with cryptographic hash chain entries cryptographically bound to TEE attestation reports; and releasing issuance authorization to an External Counterparty only after completion within the TEE of Trust-State Scoring, drift validation, Risk Weighting, Credit Issuance Gate evaluation, and Provenance Ledger recording.

3. A hardware-secured capital markets settlement subsystem comprising a trusted execution environment (TEE) comprising an Intel SGX enclave, AMD SEV-SNP protected VM, or ARM TrustZone secure world materially altering the processor state by invoking secure enclave isolation; a Settlement Attestation Binder executing within the TEE configured to cryptographically bind settlement confirmations to TEE attestation reports corresponding to the hardware environment in which the associated Trust-State Scoring, Risk Weighting, and Credit Issuance Gate authorization computations were performed, wherein each settlement confirmation includes a reference to the specific TEE attestation report identifier of the TEE execution instance that authorized the underlying issuance; a Capital Simulation Engine (also referred to herein as the Optimization and Simulation Engine) executing within the TEE configured to execute capital adequacy simulations and portfolio stress tests using hardware-attested Trust-State Scores and risk coefficients as inputs, with drift detection anchored to TEE-resident hardware mechanisms comprising enclave-sealed monitoring registers, memory encryption engine integrity states, or attestation-based recalibration triggers; and a Provenance Ledger comprising an append-only cryptographic hash chain wherein each ledger entry is cryptographically bound to a TEE attestation report corresponding to the hardware environment in which the associated computation was performed, enabling independent verification of both the settlement outcome and the hardware environment that authorized it.

4. The system of claim 1, wherein the ZKP Verification Engine encodes risk-weighting constraints, Trust-State Score thresholds, and Credit Issuance Gate authorization criteria into Groth16 arithmetic circuit structures using cryptographic libraries including libsnark and circom, with Groth16 constant-size verification complexity independent of circuit depth ensuring the under-10-millisecond verification bound holds across all supported credit scoring circuit configurations.

5. The system of claim 1, wherein the TEE-resident hardware mechanisms include memory encryption engine integrity states that encrypt all data stored in TEE memory pages, preventing extraction of scoring model parameters or issuer financial data through physical memory attacks, cold-boot attacks, or hypervisor-level memory inspection.

6. The system of claim 1, wherein the Drift Detection Anchor triggers a hardware-level recalibration alert and suspends Credit Issuance Gate authorization when the Trust-State Scoring Engine's behavioral drift metric exceeds a configurable tolerance threshold, requiring hardware-attested recalibration and generation of a new TEE attestation report before issuance processing resumes.

7. The system of claim 1, wherein the Risk Weighting Module converts Trust-State Scores into capital risk coefficients incorporating domain-specific regulatory multipliers applicable to Basel III/IV, SOLVENCY II, and applicable domestic financial regulation, with all regulatory multipliers stored in a TEE-sealed policy store that cannot be modified without generating a new hardware attestation event.

8. The system of claim 1, wherein each Provenance Ledger entry comprises a cryptographic hash of the prior ledger entry chained with the TEE attestation measurement of the current TEE execution instance, such that modification of any historical entry propagates as a detectable hash chain inconsistency through all subsequent entries.

9. The system of claim 1, wherein the ZKP Verification Engine implements Groth16 proofs using trusted setup ceremonies performed inside a TEE, with proving key rotation tied to hardware attestation events and prior proving keys invalidated using enclave-sealed revocation lists.

10. The system of claim 1, further comprising a Capital Simulation Engine executing within the TEE configured to execute capital adequacy simulations and portfolio stress tests using hardware-attested Trust-State Scores and risk coefficients, generating recalibration recommendations cryptographically bound to the TEE attestation report of the simulation execution instance.

11. The system of claim 1, wherein the Credit Issuance Gate enforces a mandatory execution barrier requiring that Trust-State Scoring, drift validation, Risk Weighting, and ZKP proof generation complete within a single attested TEE execution instance prior to enclave termination before any issuance authorization is released to an External Counterparty, with any incomplete or failed pipeline stage triggering the Rollback Controller.

12. The method of claim 2, wherein drift detection triggers hardware-level recalibration of the Trust-State Scoring Engine using enclave-sealed monitoring registers, suspending Credit Issuance Gate authorization until a new TEE attestation report is generated confirming recalibrated model integrity and a drift metric within the configured tolerance threshold.

13. The method of claim 2, wherein the Groth16 arithmetic-circuit proofs exhibit constant-size verification complexity independent of circuit depth, ensuring the under-10-millisecond verification bound holds regardless of the complexity of the credit scoring circuit configuration on standard server-grade hardware.

14. The method of claim 2, further comprising binding each issuance authorization event to a specific TEE attestation report identifier corresponding to the TEE execution instance in which the scoring and authorization computations were performed, enabling independent parties to verify that a specific hardware execution instance authorized a specific issuance event.

15. The system of claim 3, further comprising a Cross-Border Verifier configured to route TEE-attested settlement confirmations and ZKP proofs to applicable clearing houses, central banks, and regulatory verification systems across multiple legal jurisdictions, maintaining a routing manifest in the Provenance Ledger with cryptographic binding to the originating TEE attestation report for each routing event.

16. The system of claim 3, further comprising a Multi-Party ZKP Validator executing within the TEE configured to generate entity-isolated zero-knowledge proofs for multiple External Counterparties participating in a syndicated issuance or settlement event, preventing any participant from accessing another's proprietary participation data while enabling independent verification of issuance validity by all participants.

17. The system of claim 3, further comprising a Rollback Controller executing within the TEE configured to revert pending pipeline state to a pre-ingestion checkpoint upon Credit Issuance Gate denial or Drift Detection Anchor suspension, recording the reversion event in the Provenance Ledger with full TEE attestation binding and initiating a re-attestation cycle before new issuance processing resumes.

18. The system of claim 3, further comprising a Risk Calibration Loop executing within the TEE configured to incorporate Stress Test Module outputs, settlement outcomes, and Drift Detection Anchor alerts into Trust-State Scoring Engine calibration parameter updates, with all calibration updates cryptographically bound to a new TEE attestation report before application to subsequent scoring events.

19. The system of claim 3, further comprising a Coefficient Adjuster executing within the TEE configured to translate Capital Simulation Engine scenario outputs into recommended updates to Risk Weighting Module regulatory multipliers, with proposed coefficient adjustments requiring Credit Issuance Gate re-attestation confirming generation of a new TEE attestation report before application to new issuance authorization events.

20. The system of claim 3, wherein the Provenance Ledger records settlement events with cryptographic hash-chain binding to specific TEE attestation report identifiers corresponding to the TEE execution instances in which the associated Trust-State Scoring, Risk Weighting, and Credit Issuance Gate authorization computations were performed, enabling independent verification of both the settlement outcome and the identity of the hardware execution environment that authorized it.
